(19) United States
(12) Patent Application Publication
(10) Pub. No.: US 2020/0363683 A1
(43) Pub. Date: Nov. 19, 2020

(54) LIGHTING DEVICE AND DISPLAY APPARATUS

(71) Applicant: SHARP KABUSHIKI KAISHA, Osaka (JP)

(72) Inventor: SHINJI SADAMITSU, Osaka (JP)

(21) Appl. No.: 16/872,336

(22) Filed: May 11, 2020

Related U.S. Application Data
(60) Provisional application No. 62/847,541, filed on May 14, 2019.

(51) Int. Cl. G02F 1/13357; F21V 8/00; H05B 45/10; H05B 45/325

(52) U.S. Cl. CPC G02F 1/133603; G02B 6/002; G02F 2001/133613; H05B 45/325; G02F 1/133611; H05B 45/10

(57) ABSTRACT

A lighting device includes multiple light sources and a light guide plate that guides light from the multiple light sources. The light guide plate has a light incident face where light from the light sources is incident and an incident-opposite face positioned opposite to the light incident face, and also includes a first light guide portion where a distance L from the light incident face to the incident-opposite face is relatively long and a second light guide portion where the distance is relatively short. The multiple light sources include a first light source that supplies light to the first light guide portion, and a second light source that supplies light to the second light guide portion. The lighting device is configured such that a light emission quantity per unit time at the second light source is smaller than a light emission quantity per unit time at the first light source.

### TECHNICAL FIELD

Technology disclosed in the present description relates to a lighting device and a display apparatus, which use a light guide plate of which the shape is other than rectangular.

### BACKGROUND ART

In recent years, liquid crystal displays that include a liquid crystal panel, for example, have been used as display apparatuses for electronic equipment such as information terminals or the like, instruments provided in a vehicle such as automobiles or the like, and so forth (Japanese Unexamined Patent Application Publication No. 2017-139179). Liquid crystal panels do not emit light of their own, and accordingly a separate backlight device is necessary as a lighting device. Backlight devices are generally classified into direct backlight devices and edge-light backlight devices in accordance with the mechanism thereof. It is considered preferable to use edge-light backlight devices to realize further reduction in thickness of liquid crystal displays.

In edge-light backlight devices, first, light emitted from a light source such as an LED (Light Emitting Diode) or the like is incident from an end face (light incident face) of a light guide plate made of a transparent plate-like member. The light is then propagated through the light guide plate and becomes planar light that is emitted from a plate face at a front side (light-emitting face) toward a liquid crystal panel.

### SUMMARY OF INVENTION

In recent years, in-plane uniformity of white luminance has been evaluated in liquid crystal displays by White uniformity (minimum luminance/maximum luminance) estimated from minimum luminance and maximum luminance when displaying white. It is important to disperse light of LEDs or the like being a light source as uniformly as possible to raise the in-plane uniformity of white luminance.

On the other hand, in recent years, liquid crystal panels called FFDs (Free Form Displays) that have unusual shapes have been designed in addition to rectangular shapes conventionally used. In such configurations, light that enters the light guide plate from the light incident face and travels straight toward an incident-opposite face positioned at the opposite side from the light incident face exhibits luminance unevenness, since the distance from the light incident face (LED-disposed side) to the incident-opposite face (LED-non-disposed side) is not uniform. In other words, there is a problem in that the luminance is relatively high in regions where the distance is short, and the luminance is relatively low in regions where the distance is long. Such luminance unevenness leads to non-uniformness of White uniformity.

Technology disclosed in the present description is created in light of the above-described problem, and it is an object thereof to provide technology that enables uniformity of luminance distribution to be improved.

### Solution to Problem

(1) An embodiment of the present invention is a lighting device including multiple light sources and a light guide plate that guides light from the multiple light sources. The light guide plate has a light incident face where light from the light sources is incident and an incident-opposite face positioned opposite to the light incident face, and also includes a first light guide portion where a distance from the light incident face to the incident-opposite face is relatively long, and a second light guide portion where the distance is relatively short. The multiple light sources include a first light source that supplies light to the first light guide portion and a second light source that supplies light to the second light guide portion. The lighting device is configured such that a light emission quantity per unit time at the second light source is smaller than a light emission quantity per unit time at the first light source.

(2) Also, an embodiment of the present invention is a lighting device further including, in addition to the configuration of (1) above, a light quantity adjusting unit that adjusts the light emission quantity per unit time at the second light source to be smaller than the light emission quantity per unit time at the first light source.

(3) Also, an embodiment of the present invention is a lighting device where, in addition to the configuration of (2) above, the light quantity adjusting unit is a PWM control unit that controls the light emission quantity per unit time at the light sources by varying duty ratios in accordance with the distance.

(4) Also, an embodiment of the present invention is a lighting device where, in addition to the configuration of (2) above, the light quantity adjusting unit adjusts a light emission quantity per unit time by varying a value of current supplied to the multiple light sources.

(5) Also, an embodiment of the present invention is a lighting device further including, in addition to the configuration of (4) above, multiple systems in each of which light sources among the multiple light sources are connected in series, where each of the systems is driven at a corresponding constant current, and the light quantity adjusting unit is a resistor element that is connected in parallel to at least one of the light sources included in one of the systems so that a value of electric current flowing to the at least one light source differs.

(6) Also, an embodiment of the present invention is a lighting device where, in addition to the configuration of (1) above, the multiple light sources having luminous intensity ranks different from each other are arrayed.

(7) Also, an embodiment of the present invention is a display apparatus including the lighting device according to any one of (1) through (6) above, and a display panel that displays an image by using light radiated from the lighting device.

According to the technology disclosed in the present description, uniformity of luminance distribution can be improved.

### BRIEF DESCRIPTION OF DRAWINGS

FIG. 1 is a partial enlarged sectional view of a liquid crystal display according to Embodiment 1.

FIG. 2 is a plan view illustrating a layout of a light guide plate and LEDs.

FIG. 3 is a circuit diagram illustrating a circuit configuration for driving the LEDs.

FIG. 4 illustrates graphs representing lighting periods and non-lighting periods of the LEDs.

FIG. 5 is a table representing duty ratios of the LEDs.

FIG. 6 is a circuit diagram illustrating a circuit configuration for driving the LEDs according to Embodiment 2.

FIG. 7 is a table representing duty ratios of the LEDs.

FIG. 8 is a table representing values of currents flowing through the LEDs according to Embodiment 3.

FIG. 9 is a table representing values of currents flowing through the LEDs according to Embodiment 4.

FIG. 10 is a circuit diagram illustrating a circuit configuration for driving the LEDs according to Embodiment 5.

FIG. 11 is a table representing luminous intensities of the LEDs according to Embodiment 6.

FIG. 12 is a plan view illustrating a layout of a light guide plate and LEDs according to another embodiment.

### DESCRIPTION OF EMBODIMENTS

### Embodiment 1

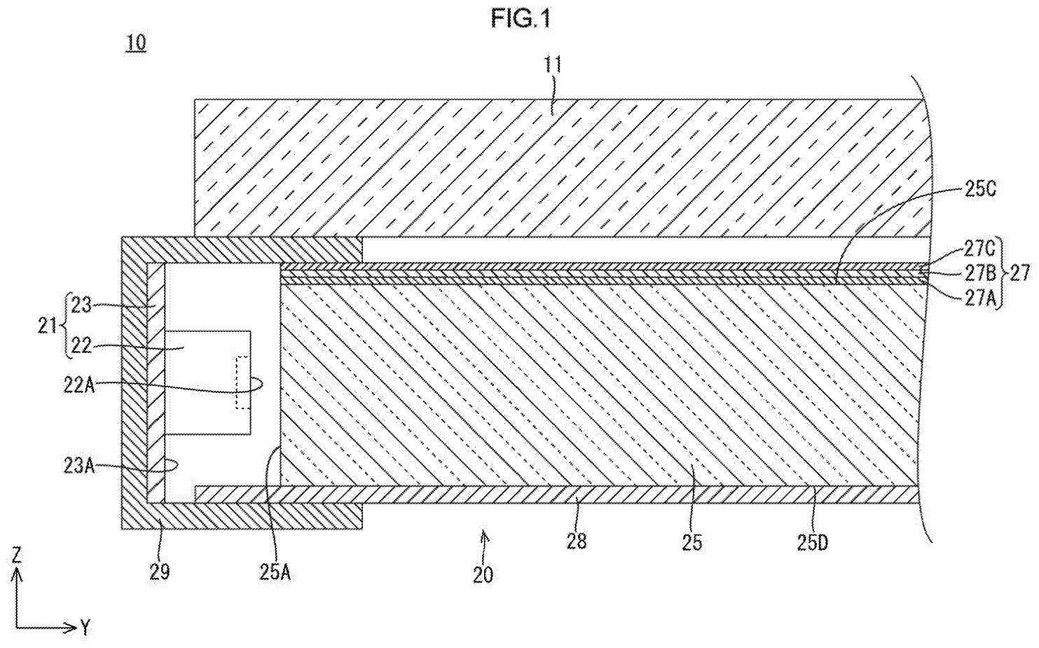

Embodiment 1 is described with reference to FIG. 1 through FIG. 5. A liquid crystal display (an example of a display apparatus) 10 that has a liquid crystal panel 11 as a display panel is exemplified in the present embodiment. Note that an X-axis, a Y-axis, and a Z-axis are illustrated in some of the drawings, and the drawings are drawn so that the axial directions agree with the directions illustrated in the drawings. FIG. 1 serves as a reference for the up-down direction, with the upper side in this drawing being a front side and the lower side in this drawing being a rear side. Regarding two or more members that are the same, one of the members may be denoted by a symbol and symbols may be omitted for the other members.

The liquid crystal display 10 overall has a hexagonal flat-box-like shape that is laterally elongated, in which the liquid crystal panel (an example of a display panel) 11 that is capable of displaying images and a backlight device (an example of a lighting device) 20 that is disposed on the rear side of the liquid crystal panel 11 and that supplies light to the liquid crystal panel 11 for display are integrally held. The liquid crystal display 10 according to the present embodiment is assembled into a dashboard of an automobile, for example, and used. The liquid crystal display 10 makes up part of an instrument panel and is capable of displaying some instruments of the instrument panel, various types of warning images, map images of an automotive navigation system, images taken by an onboard camera, and so forth. Note that the liquid crystal display 10 is not restricted to the above-described usages, and the present technology can be applied to various usages.

The liquid crystal panel 11 has a known configuration, where a pair of glass substrates that are transparent (have a high degree of transparency) are bonded to each other with a predetermined gap therebetween with a liquid crystal layer sealed in between both of the glass substrates. Provided on one of the glass substrates are switching devices (e.g., TFTs) connected to source lines and gate lines that are orthogonal to each other, pixel electrodes connected to the switching devices, an alignment film, and so forth. Provided on the other glass substrate is a color filter where coloring portions of R (red), G (green), B (blue), and the like are laid out in a predetermined array, an opposing electrode, an alignment film, and so forth. Of these, the source lines, the gate lines, the opposing electrode, and so forth are arranged to be supplied with image data necessary to display images, and with various types of control signals, from a driving circuit board. Note that a polarizing plate is disposed on the outer side of each of the glass substrates.

The liquid crystal panel 11 according to the present embodiment has a plate-like hexagonal shape that is laterally elongated in plan view. More specifically, the liquid crystal panel 11 is a so-called FFD (Free Form Display) that has an overall hexagonal shape that is laterally elongated, with corner portions obliquely cut away between one long side of the pair of long sides of a rectangle that is laterally elongated and a pair of short sides connecting to this long side. The liquid crystal panel 11 can display images by using light supplied from the backlight device 20. The front side of the backlight device 20 is the light-emitting side. Note that in the liquid crystal panel 11, the long-side direction of the rectangle before cutting away matches the X-axis direction, the short-side direction matches the Y-axis direction, and further the thickness direction matches the Z-axis direction.

The backlight device 20 overall has a block-like hexagonal shape that is laterally elongated in plan view in the same way as the liquid crystal panel 11. The backlight device 20 has at least an LED unit 21 made up of multiple LEDs (light-emitting diodes) 22 which are light sources and an LED board 23 on which the LEDs 22 are mounted, a light guide plate 25 that guides light emitted from the LEDs 22, multiple optical sheets 27 that are layered and disposed on the front side of the light guide plate 25, a reflecting sheet 28 disposed on the rear side of the light guide plate 25, and a bezel 29.

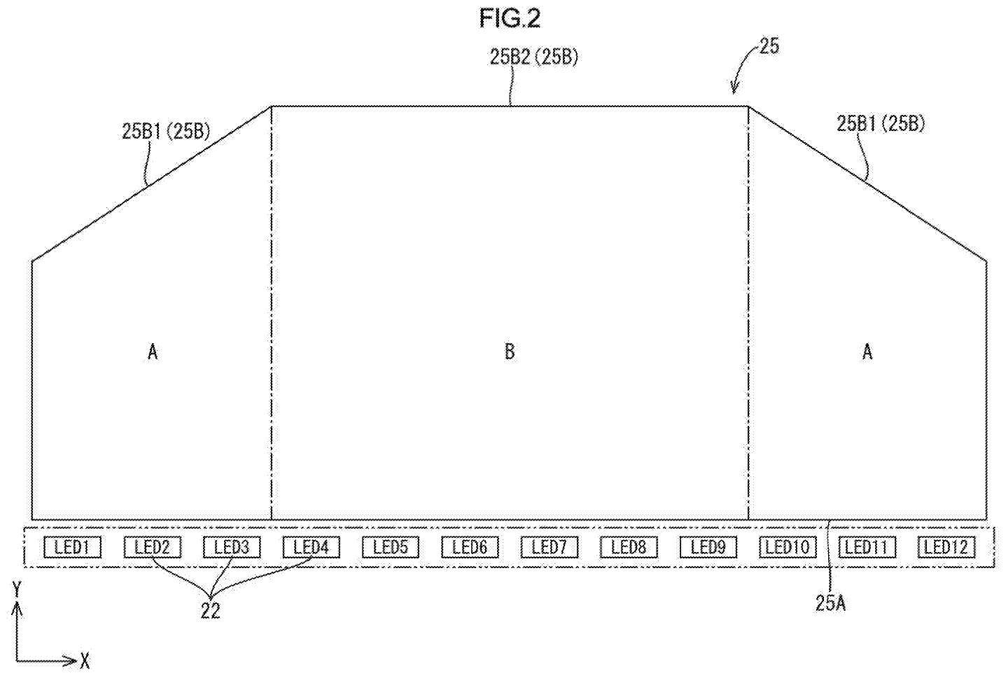

The backlight device 20 is an edge-light type (side light type), which is a one-side light input type, where light is input to the light guide plate 25 from one side alone due to the LEDs 22 being disposed on the longest end face (end face at the lower side in FIG. 2) of the light guide plate 25, which is described next. The backlight device 20 converts light from the LEDs 22 into planar light, and emits the converted planar light toward the liquid crystal panel 11 at the front side. That is to say, the front side of the backlight device 20 is the light-emitting side. Hereinafter, constituent parts of the backlight device 20 are described in order.

First, the light guide plate 25 is described. The light guide plate 25 has a plate-like hexagonal shape that is laterally elongated in plan view in the same way as the liquid crystal panel 11 described above. Regarding the light guide plate 25, a light guide plate formed from a material that has a refractive index sufficiently higher than air and has excellent transparency, such as a resin, for example, transparent acrylic resin, polycarbonate resin, or the like, or various types of glass, can be used. The light guide plate 25 according to the present embodiment is made of an acrylic resin. Note that in the light guide plate 25, the long-side direction of the rectangle before cutting away the corner portions matches the X-axis direction, the short-side direction matches the Y-axis direction, and the thickness direction matches the Z-axis direction (see FIG. 2).

The longest end face (the end face at the lower side in FIG. 2) of the end faces on the periphery of the light guide plate 25 is a light incident face 25A which faces light-emitting faces 22A of the later-described LEDs 22 in parallel and on which light from the LEDs 22 is incident. Also, in the present embodiment, the end face at the opposite side from the light incident face 25A is referred to as an incident-opposite face 25B, the upper face (front face) of a pair of plate faces is referred to as a light-emitting face 25C that emits light toward the liquid crystal panel 11, and the lower face (rear face) of the pair of plate faces is referred to as an emitting-opposite face 25D.

A large number of irregularity patterns are provided on the emitting-opposite face 25D of the light guide plate 25 and have a function of propagating light entered from the light incident face 25A through the light guide plate 25 while directing the light in the Z-axis direction by the irregularity patterns so as to be emitted from the light-emitting face 25C toward the front side (liquid crystal panel 11 side). The light guide plate 25 is disposed at a position directly below the liquid crystal panel 11 with the optical sheets 27 interposed therebetween.

The optical sheets 27 have a sheet-like hexagonal shape that is laterally elongated in the same way as the light guide plate 25 and are layered on the light-emitting face 25C of the light guide plate 25. The optical sheets 27 are interposed between the light guide plate 25 and the liquid crystal panel 11, thereby transmitting light that is emitted from the light guide plate 25 and emitting the light that is transmitted toward the liquid crystal panel 11 while imparting a predetermined optical effect to the light transmitted. The optical sheets 27 according to the present embodiment have a three-layered structure. A diffusing sheet 27A, a lens sheet 27B, and a reflective polarizing sheet 27C are overlaid in order from the lower side.

On the other hand, the reflecting sheet 28 is layered on the rear face side (emitting-opposite face 25D side) of the light guide plate 25. The reflecting sheet 28 has a flat sheet-like hexagonal shape that is laterally elongated in the same way as the light guide plate 25. The reflecting sheet 28 is made of a synthetic-resin sheet material of which the surface exhibits a white color with excellent reflectivity, and can efficiently direct light that is propagated through the light guide plate 25 and emitted from the emitting-opposite face 25D toward the front side (light-emitting face 25C side). Also, the reflecting sheet 28 is larger than the emitting-opposite face 25D of the light guide plate 25 to some extent, and the end edge of the reflecting sheet 28 extends slightly beyond the end portion of the light guide plate 25, as illustrated in FIG. 1.

The bezel 29 is disposed on the light incident face 25A and the incident-opposite face 25B of the light guide plate 25. The bezel 29 is made of a metal material (e.g., aluminum) and has an overall U-shaped channel structure in cross-section that opens toward the light guide plate 25 in a form that covers the end portion of the light guide plate 25 from a position away from the light incident face 25A while nipping the light guide plate 25 from the front and rear sides with the optical sheets 27 and reflecting sheet 28 interposed therebetween. Note that the above-described liquid crystal panel 11 is fixed to the front side (outer peripheral side) of the bezel 29 by fixing tape or the like.

Next, the LED unit 21 is described. The LED unit 21 is formed of the LEDs 22 and the LED board 23. The LED board 23 has a slender strip shape extending along the light incident face 25A (in the X-axis direction) of the light guide plate 25 and is accommodated within the bezel 29 assuming an orientation where one board face thereof is parallel to the X-axis direction and Z-axis direction, i.e., an orientation parallel to the light incident face 25A of the light guide plate 25. The dimensions of the LED board 23 in the long-side direction (X-axis direction) thereof are substantially the same as the dimensions in the lengthwise direction of the light incident face 25A of the light guide plate 25. Multiple LEDs 22 are surface-mounted on the board face (opposed to the light guide plate 25) of the LED board 23 facing the light guide plate 25. This face is a mounting face 23A. A wiring pattern that is made of a metal film such as copper foil or the like and that extends in the X-axis direction and connects predetermined LEDs 22 in series to each other is formed on the mounting face 23A of the LED board 23. Terminal portions formed in the wiring pattern are connected to a power supply board and a LED driving board 30 via wiring members such as connectors, electric wires, and so forth, with which driving power is supplied to the LEDs 22, and the LEDs 22 are driven. The board face of the LED board 23 on the opposite side from the mounting face 23A is attached to the bezel 29 by screws or the like.

Multiple LEDs 22 that make up the LED unit 21 are linearly arrayed in the lengthwise direction (X-axis direction) on the mounting face 23A of the LED board 23 in a single row with predetermined intervals therebetween. In other words, multiple LEDs 22 are disposed in a row at predetermined intervals along the light incident face 25A of the light guide plate 25 (see FIG. 2). The LEDs 22 are so-called top-emitting-type LEDs, where a face thereof (a face that faces the light incident face 25A of the light guide plate 25) opposite to the mounting face of the LED board 23 is a principal light-emitting face.

The LEDs 22 have a configuration where LED chips (LED elements), which are semiconductor light-emitting elements, are sealed by a resin material on a board portion fixed onto the board face of the LED board 23. The LED chips mounted on the board portion have one dominant emission wavelength, and specifically, LED chips that emit blue light are used. On the other hand, a phosphor that emits light of a predetermined color upon being excited by the blue light emitted from the LED chips is dispersedly mixed into the resin material that seals the LED chips. Overall, a substantially white-color light is emitted.

In the present embodiment as described above, twelve LEDs 22 are disposed in a single row along the light incident face 25A of the light guide plate 25, with predetermined intervals therebetween. These LEDs are LED-1, LED-2, LED-3, LED-4, LED-5, LED-6, LED-7, LED-8, LED-9, LED-10, LED-11, and LED-12 in order from the left side in FIG. 2. Partial regions (end-portion-side regions) of the incident-opposite face 25B positioned at the opposite side from partial regions of the light incident face 25A of the light guide plate 25 where the three LEDs, LED-1, LED-2, and LED-3, from the left end, and the three LEDs, LED-12, LED-11, and LED-10, from the right end are disposed, are oblique portions 25B1 that are obliquely positioned with respect to the light incident face 25A due to the corner portions at both ends in plan view having been cut away. On the other hand, a partial region of the incident-opposite face 25B positioned at the opposite side from a partial region of the light incident face 25A where the LED-4 through LED-9 in the middle are disposed is a parallel portion 25B2 that is positioned parallel to the light incident face 25A in plan view. A distance from the light incident face 25A to the incident-opposite face 25B (referred to as distance L) is shorter at the oblique portions 25B1 than at the parallel portion 25B2. Note that the number of LEDs 22 used is not restricted to the above embodiment and can be changed as appropriate.

The backlight device 20 that is an edge-light type has a configuration where multiple LEDs 22 are arrayed at the end portion of the light guide plate 25. In the backlight device 20 of an FFD type such as described above, the distribution of light quantity regarding light emitted from the LEDs 22 is low when the distance L from the light incident face 25A to the incident-opposite face 25B is relatively long, and conversely is high when the distance L is relatively short. In other words, the distribution of light quantity in the light guide plate 25 according to the present embodiment is low at the middle side (an example of a first light guide portion, a region corresponding to LED-4 through LED-9) where the distance L is relatively long, and gradually increases over the end portion sides (an example of a second light guide portion, LED-3 through LED-1 and LED-10 through LED-12) where the distance L is relatively short. This is because when the distance L is long, the light quantity of the LEDs 22 that is reflected by the emitting-opposite face 25D is relatively small per unit area, and such imbalance in distribution of light quantity is a cause of luminance unevenness of the liquid crystal panel 11 and is furthermore a cause of non-uniformity of white luminance.

Accordingly, the backlight device 20 according to the present embodiment is provided with a middle-side LED driving unit (an example of a light quantity adjusting unit) 24A that controls light emission quantity per unit time of LED-4 through LED-9 (an example of a first light source) at the middle side, and end-portion-side LED driving units (an example of light quantity adjusting units) 24B, 24C, and 24D that control light emission quantity per unit time of LED-1 through LED-3 and LED-10 through LED-12 (an example of a second light source) at the end portion sides where the distance L is short in comparison with the LED-4 through LED-9 at the middle side, so as to be smaller than the light emission quantity per unit time of the LED-4 through LED-9 at the middle side. The middle-side LED driving unit 24A and the end-portion-side LED driving units 24B, 24C, and 24D are provided on the LED driving board 30 for driving the LEDs 22. Note that in the following, in a case where individual LEDs 22 are to be distinguished, a single-digit numeral indicating the position in the array is appended to “LED-” and in a case of collective reference without individually distinguishing the LEDs 22, the numeral 22 for the LEDs is used. Also, in a case of distinguishing the LED driving units 24A, 24B, 24C, and 24D, additional characters A, B, C, or D is appended to the symbol of LED driving unit 24, and in a case of collective reference without individually distinguishing the LED driving units 24A, 24B, 24C, and 24D, no additional character is appended to the symbol of LED driving unit 24.

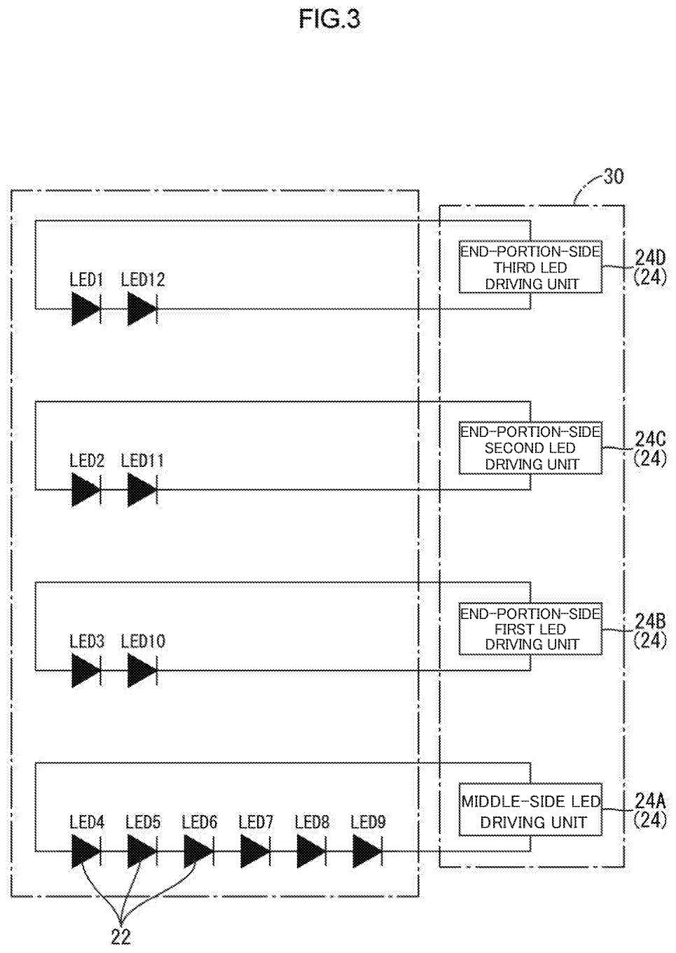

The LED driving units 24 are provided with the middle-side LED driving unit 24A that is connected to the middle side LED-4 through LED-9 which are connected in series and that controls driving so that the light emission quantity per unit time thereof is relatively large, and the end-portion-side first LED driving unit 24B, end-portion-side second LED driving unit 24C, and end-portion-side third LED driving unit 24D that control driving so that the light emission quantity per unit time is reduced incrementally and relatively from the sides closer to the LED-4 through LED-9 at the middle side toward the end portion sides, as illustrated in FIG. 3. The light emission quantity per unit time of the LEDs 22 is LED-4 through LED-9>LED-3 and LED-10>LED-2 and LED-11>LED-1 and LED-12 in this order from the middle side by using the LED driving units 24 and is set to be gradually reduced toward the end portion sides.

In more detail, the middle-side LED driving unit 24A controls driving such that the light emission quantity per unit time of the multiple LED-4 through LED-9 is the greatest of all the LEDs 22. The end-portion-side first LED driving unit 24B controls driving of the LED-3 and LED-10 that are connected in series, such that the light emission quantity thereof per unit time is greatest following the light emission quantity of the LED-4 through LED-9, and greater than that of the LED-2 and LED-11. The end-portion-side second LED driving unit 24C controls driving of the LED-2 and LED-11 that are connected in series, such that the light emission quantity thereof per unit time is less than the light emission quantity per unit time of the LED-3 and LED-10, but greater than the light emission quantity per unit time of the LED-1 and LED-12. The end-portion-side third LED driving unit 24D controls driving of the LED-1 and LED-12 that are connected in series, such that the light emission quantity thereof per unit time is the smallest of all the LEDs 22.

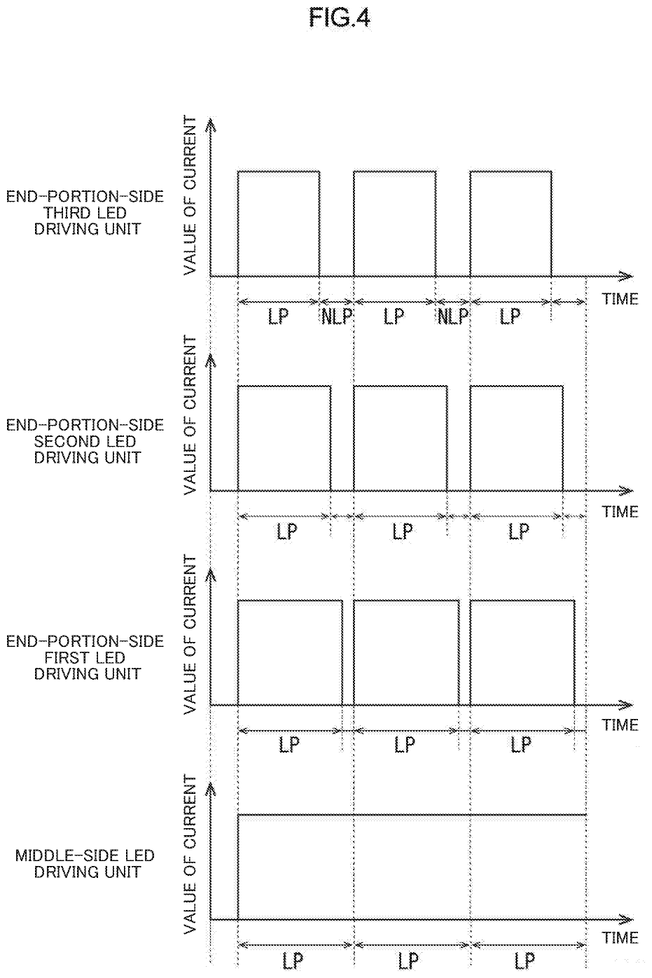

The LED driving units 24 according to the present embodiment supply pulse signals to the LEDs 22 and adjust the time ratio (duty ratio) between a lighting period LP and a non-lighting period (turned-off period) NLP of the LEDs 22, thereby controlling the light emission quantity per unit time, as illustrated in FIG. 4. In other words, the LED driving units 24 are PWM (Pulse Width Modulation) control units that perform PWM lighting control driving where the LEDs 22 are made to cyclically blink, and the time ratios between the lighting periods LP and non-lighting periods NLP thereof are varied.

Specifically, the duty ratio of the middle-side LED driving unit 24A is set to 100% (only turned on) in the present embodiment. The end-portion-side first LED driving unit 24B performs lighting control driving of the LED-3 and LED-10 by supplying pulse signals to the LED-3 and LED-10 so that the lighting period LP of the LED-3 and LED-10 is relatively short in comparison with the LED-4 through LED-9 at the middle side and the non-lighting period NLP is relatively long, while the lighting period LP of the LED-3 and LED-10 is relatively long in comparison with the LED-2 and LED-11 controlled by the end-portion-side second LED driving unit 24C and LED-1 and LED-12 controlled by the end-portion-side third LED driving unit 24D and the non-lighting period NLP is relatively short.

In the same way, the end-portion-side second LED driving unit 24C performs lighting control driving of the LED-2 and LED-11 by supplying pulse signals to the LED-2 and LED-11 so that the lighting period LP of the LED-2 and LED-11 is relatively short in comparison with the LED-3 and LED-10 and the non-lighting period NLP is relatively long, while the lighting period LP of the LED-2 and LED-11 is relatively long in comparison with the LED-1 and LED-12 controlled by the end-portion-side third LED driving unit 24D and the non-lighting period NLP is relatively short.

The end-portion-side third LED driving unit 24D performs lighting control driving of the LED-1 and LED-12 by supplying pulse signals to the LED-1 and LED-12 so that the lighting period LP of the LED-1 and LED-12 is relatively short in comparison with the LED-2 and LED-11 and the non-lighting period NLP is relatively long.

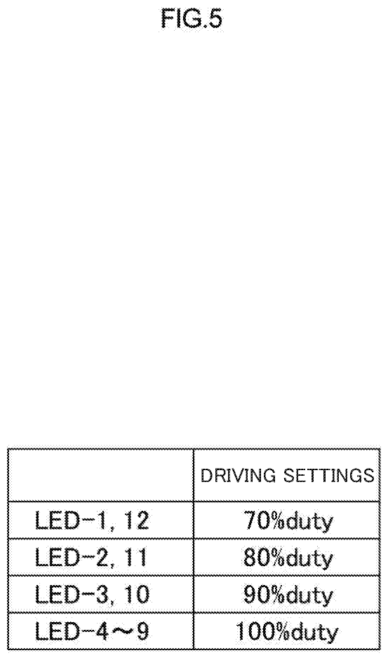

In the present embodiment, the LED driving units 24 drive at a duty ratio of 100% at the LED-4 through LED-9, a duty ratio of 90% at the LED-3 and LED-10, a duty ratio of 80% at the LED-2 and LED-11, and a duty ratio of 70% at the LED-1 and LED-12, as shown in the table in FIG. 5. Note that the values of current flowing from the LED driving units 24 are the same.

The liquid crystal display 10 according to the present embodiment has the configuration described above. Next, effects and advantages are described. The backlight device 20 according to the present embodiment is provided with the multiple LEDs 22 and the light guide plate 25 that guides light from the multiple LEDs 22. The light guide plate 25 has the light incident face 25A where light from the LEDs 22 is incident and the incident-opposite face 25B positioned at the opposite side from the light incident face 25A, and also includes the first light guide portion where the distance L from the light incident face 25A to the incident-opposite face 25B is relatively long and the second light guide portions where the distance L is relatively short. The multiple LEDs 22 include the LED-4 through LED-9 that supply light to the first light guide portion, and the LED-1 through LED-3 and LED-10 through LED-12 that supply light to the second light guide portions and are configured such that the light emission quantity per unit time of the LED-1 through LED-3 and LED-10 through LED-12 is less than the light emission quantity per unit time of the LED-4 through LED-9.

According to this configuration, a difference in light quantity of light that is emitted, depending on the position, does not readily occur even when the light guide plate 25 that is an FFD type is used as in the present embodiment. In other words, a liquid crystal panel 11 and liquid crystal display 10 where luminance unevenness is suppressed, and furthermore white luminance unevenness is suppressed, can be obtained.

Also provided is the LED driving units 24 that adjust the light emission quantity per unit time at the LED-1 through LED-3 and LED-10 through LED-12 so as to be smaller than the light emission quantity per unit time of the LED-4 through LED-9. According to this configuration, the LED driving units 24 can control the multiple LEDs 22 individually in accordance with the distance L and adjust the light emission quantity thereof.

Further, the LED driving units 24 are PWM control units that control the light emission quantity per unit time of the LEDs 22 with different duty ratios in accordance with the distance L. According to this configuration, driving of the LEDs 22 in accordance with the distance L can be realized.

### Embodiment 2

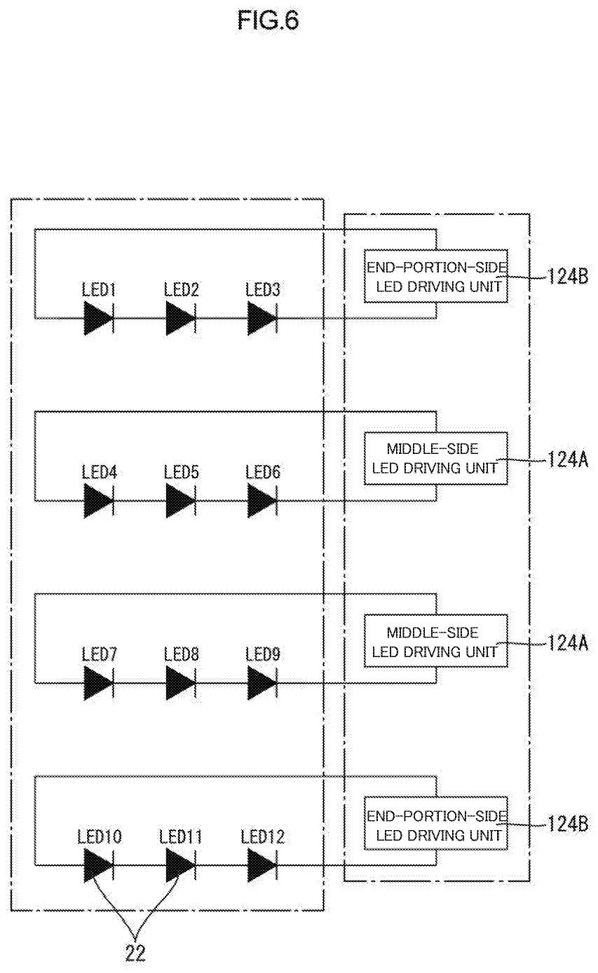

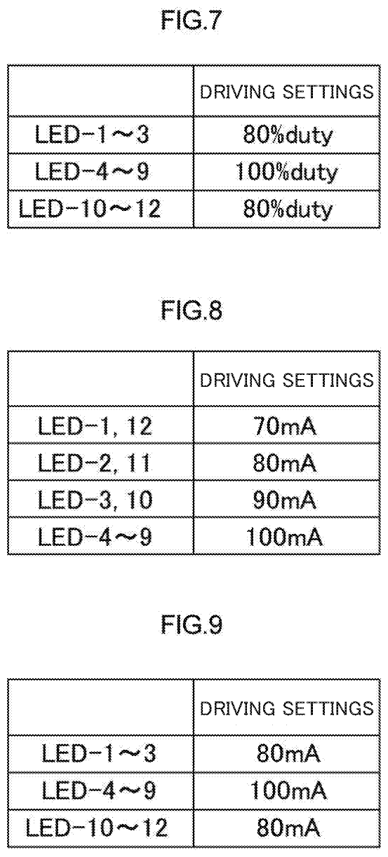

Embodiment 2 is described with reference to FIG. 6 and FIG. 7. Note that only configurations that are different from Embodiment 1 are described below. Configurations that are the same as in Embodiment 1 are denoted by the same symbols, and redundant description is omitted.

The present embodiment differs from the above Embodiment 1 with regard to the method by which the multiple LEDs 22 are connected to LED driving units 124. In the present embodiment, the LED-4 through LED-9 at the middle side are divided into LED-4 through LED-6 and LED-7 through LED-9 and two circuit systems where three adjacent LEDs 22 are connected in series are provided, and a middle-side LED driving unit 124A is provided to each circuit. These LED-4 through LED-6 and LED-7 through LED-9 radiate the same quantity of light to a region corresponding to the parallel portion 25B2 of the light guide plate 25 (referred to as region B, see FIG. 2).

At the end portion sides of the light guide plate 25 as well, two circuit systems where three adjacent LEDs 22 (LED-1 through LED-3 and LED-10 through LED-12) are connected in series are provided in the same way, and an end-portion-side LED driving unit 124B is provided to each circuit. These LED-1 through LED-3 and LED-10 through LED-12 radiate a relatively smaller light quantity than the middle-side LED-4 through LED-9 to regions corresponding to the parallel portion 25B2 of the light guide plate 25 (referred to as regions A, see FIG. 2), so that the quantity is the same at each of the LED-1 through LED-3 and the LED-10 through LED-12. In other words, the light emission quantity per unit time of the LEDs 22 is made to be LED-4 through LED-6=LED-7 through LED-9>LED-1 through LED-3=LED-10 through LED-12, in order from the middle side by using the LED driving units 124A and 124B.

Specifically, in the present embodiment, the LED-4 through LED-6 and LED-7 through LED-9 at the middle side are each driven at a duty ratio of 100%, and the LED-1 through LED-3 and LED-10 through LED-12 at the end portion sides are driven at a duty ratio of 80%, by the respective LED driving units 124, as illustrated in the table in FIG. 7.

According to the present embodiment, in addition to the effects and advantages the same as those of Embodiment 1, a different quantity of light can be radiated for each region in accordance with the distance L, even in a case where the number of LEDs 22 connected in series and driven needs to be equal due to the circuit configuration.

### Embodiment 3

Next, Embodiment 3 is described with reference to FIG. 8. Note that only configurations that are different from Embodiment 1 are described below. Configurations that are the same as in Embodiment 1 are denoted by the same symbols, and redundant description is omitted.

The circuit configuration (the way in which the LEDs 22 are connected) of the backlight device according to the present embodiment is the same as that of Embodiment 1 illustrated in FIG. 3, but the method of adjusting the light emission quantity of the LEDs 22 by the LED driving units 24 (an example of a light quantity adjusting unit) differs from Embodiment 1 above. In other words, in Embodiment 1 above, the LED driving units 24 are PWM control units and have a configuration of adjusting the light emission quantity by varying the LED lighting periods, but in the present embodiment, a configuration is made where the light emission quantity is adjusted by varying the values of current flowing by using the LED driving units 24.

Specifically, in the present embodiment, current of 100 mA flows by using the middle-side LED driving unit 24A at the LED-4 through LED-9 at the middle side, current of 90 mA flows by using the end-portion-side first LED driving unit 24B at the LED-3 and LED-10 at the end portion side, current of 80 mA flows by using the end-portion-side second LED driving unit 24C at the LED-2 and LED-11 further at the end portion side, and current of 70 mA flows by using the end-portion-side third LED driving unit 24D at the LED-1 and LED-12 disposed farthest at the end portion, as illustrated in the table in FIG. 8. In other words, the light emission quantity per unit time of the LEDs 22 is set to be LED-4 through LED-9>LED-3 and LED-10>LED-2 and LED-11>LED-1 and LED-12, in order from the middle side so as to be gradually reduced toward the end portion sides by the LED driving units 24A through 24D.

In this way, the value of current supplied to multiple LEDs 22 connected in series is made to differ for each LED driving unit 24, and accordingly the light emission quantity per unit time can be adjusted in accordance with the distance L.

### Embodiment 4

Next, Embodiment 4 is described with reference to FIG. 9. The circuit configuration (the way in which the LEDs 22 are connected) of the backlight device according to the present embodiment is the same as that of Embodiment 2 illustrated in FIG. 6, but the method of adjusting the light emission quantity by the LED driving units 124 (an example of a light quantity adjusting unit) differs from Embodiment 2 above. In the present embodiment, a configuration is made where the light emission quantity is adjusted by varying the values of current flowing by using the LED driving units 124 to the LEDs 22, in the same way as in Embodiment 3.

Specifically, in the present embodiment, current of 100 mA flows by using the middle-side LED driving units 124A at the LED-4 through LED-6 and LED-7 through LED-9 at the middle side, and current of 80 mA flows by using the end-portion-side LED driving units 124B at the LED-1 through LED-3 and LED-10 through LED-12 at the end portion sides, as illustrated in the table in FIG. 9. In other words, the light emission quantity per unit time of the LEDs 22 is LED-4 through LED-6=LED-7 through LED-9>LED-1 through LED-3=LED-10 through LED-12, in order from the middle side, by the LED driving units 124A and 124B.

According to the present embodiment, a different quantity of light can be radiated to each region of the light guide plate 25 (regions A and region B) in accordance with the distance L, in the same way as in Embodiment 2.

### Embodiment 5

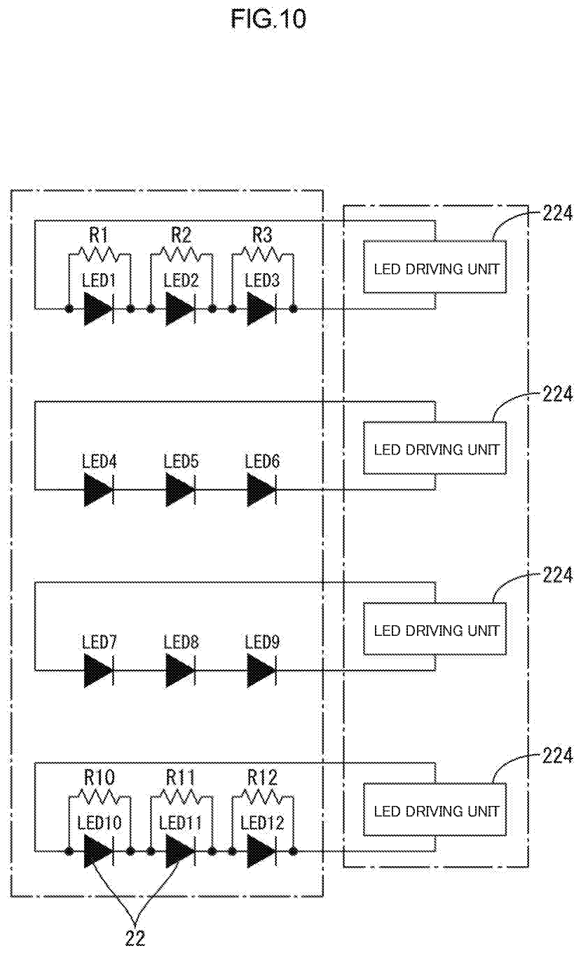

Next, Embodiment 5 is described with reference to FIG. 10. Note that only configurations that are different from Embodiment 1 are described below. Configurations that are the same as in Embodiment 1 are denoted by the same symbols, and redundant description is omitted.

The method by which the multiple LEDs 22 are connected in the backlight device according to the present embodiment uses a configuration where three adjacent LEDs 22 are connected in series, the same as that in Embodiment 2 illustrated in FIG. 6, but the method of adjusting the light emission quantity of the LEDs 22 differs from the embodiments described above. Specifically, in the present embodiment, circuits are provided as four systems where three of twelve LEDs 22 are each connected in series in order from the edge, and similar LED driving units 224 are provided to respective circuits. The circuits are driven at a constant current (100 mA).

Of these, light having a light emission quantity corresponding to current of 100 mA is emitted from the LEDs 22 (LED-4 through LED-6 and LED-7 through LED-9) of the two systems where the LED-4 through LED-6 and LED-7 through LED-9 at the middle side are each connected in series. On the other hand, current of 100 mA flows in the same way from each of the two LED driving units 224 connected to the LED-1 through LED-3 and the LED-10 through LED-12, but the light emission quantity of the LEDs 22 is different from each other. In other words, a resister element (an example of a light quantity adjusting unit) R is individually connected to the LED-1 through LED-3 and LED-10 through LED-12 in parallel, and part of the current flowing thus flows to the resistor element R side. Accordingly, the values of current flowing to the respective LEDs 22 are different.

Specifically, in the present embodiment, the current of 100 mA flowing by the LED driving units 224 as described above flows without change at the LED-4 through LED-6 and LED-7 through LED-9 at the middle side as illustrated in the table in FIG. 8, and light corresponding to the value of the current (100 mA) is emitted. Of the 100 mA current flowing by the LED driving unit 224, 90 mA flows to the LED-3 and LED-10 at the end portion sides, and the remaining 10 mA flows to resistor elements R3 and R10. In the same way, of the 100 mA current flowing by the LED driving unit 224, current of 80 mA flows to the LED-2 and LED-11 further at the end portion sides, and the remaining 20 mA flows to resistor elements R2 and R11. Moreover, of the 100 mA current flowing by the LED driving unit 224, 70 mA flows to the LED-1 and LED-12 disposed the farthest at the end portions, and the remaining 30 mA flows to resistor elements R1 and R12. In other words, the light emission quantity per unit time of the LEDs 22 is LED-4 through LED-9>LED-3 and LED-10>LED-2 and LED-11>LED-1 and LED-12 in that order from the middle side, and are set to gradually be reduced toward the end portion sides.

In this way, a resistor element R is connected in parallel to each of the LEDs 22 connected in series in the respective systems, and the value of current supplied to the LEDs 22 is made to vary, whereby the light emission quantity of the LEDs 22 can be individually adjusted in accordance with the distance L.

### Embodiment 6

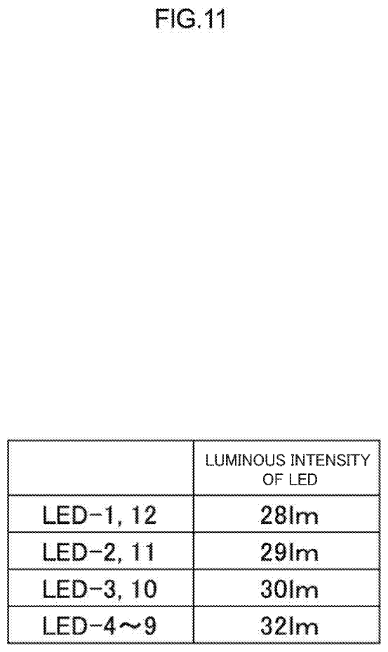

Next, Embodiment 6 is described with reference to FIG. 11. In the backlight device according to the present embodiment, the light emission quantity of the LEDs is adjusted by arraying multiple LEDs with different luminous intensity ranks. Specifically, LEDs with a relatively high luminous intensity rank are used for the LED-4 through LED-9 disposed at the middle side, and the luminous intensity rank gradually decreases over the LEDs at the end portion sides, as illustrated in the table in FIG. 11.

According to the present embodiment, a backlight device and liquid crystal display where the light quantity is adjusted in accordance with the distance L can be obtained simply by connecting multiple LEDs in series without providing complicated circuits.

### Other Embodiments

The present invention is not restricted to the embodiments described above by way of the description and drawings, and for example, embodiments such as those below are also included in the technical scope of the present invention.

(1) The configuration of the LEDs 22 is not restricted to those in the above embodiments, and LEDs 22 of various configurations can be used.

(2) The number of the LEDs 22 used is not restricted to the number in the above embodiments, and the technology of the present invention can be applied to configurations that use a large number of LEDs.

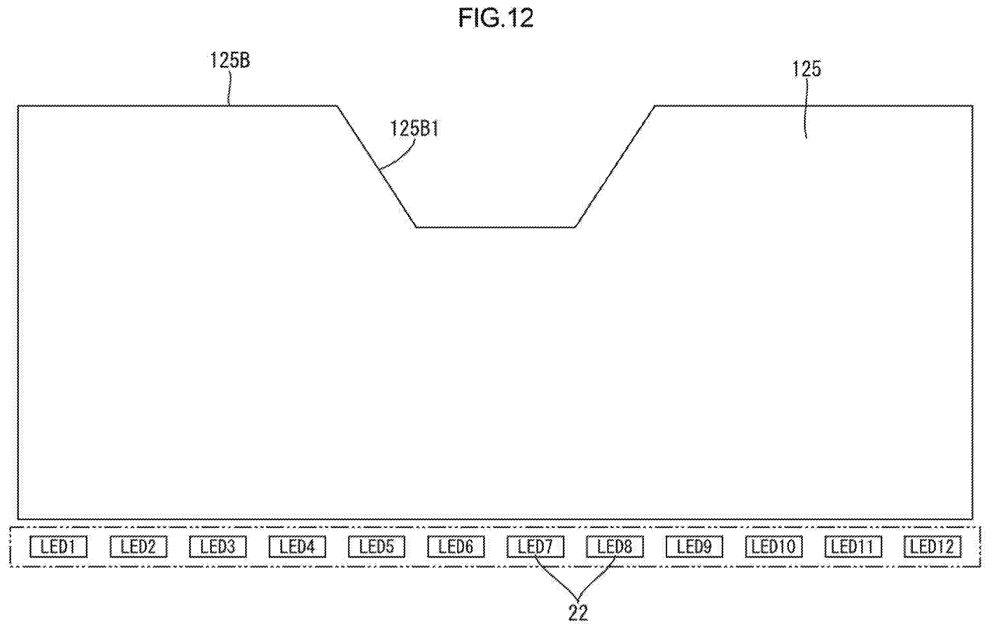

(3) Regarding the mode of the light guide plate 25, any mode is usable. For example, the technology of the present invention can be applied to a light guide plate 125 having a notched portion 125B1 that is recessed at the middle portion of an incident-opposite face 125B, as illustrated in FIG. 12.

1. A lighting device, comprising:
a plurality of light sources; and a light guide plate that guides light from the plurality of light sources, wherein
the light guide plate has a light incident face where light from the light sources is incident and an incident-opposite face positioned opposite to the light incident face, and includes a first light guide portion where a distance from the light incident face to the incident-opposite face is relatively long and a second light guide portion where the distance is relatively short,
the plurality of light sources include a first light source that supplies light to the first light guide portion and a second light source that supplies light to the second light guide portion, and
a light emission quantity per unit time at the second light source is smaller than a light emission quantity per unit time at the first light source.

2. The lighting device according to claim 1, further comprising: a light quantity adjusting unit that adjusts the light emission quantity per unit time at the second light source to be smaller than the light emission quantity per unit time at the first light source.

3. The lighting device according to claim 2, wherein the light quantity adjusting unit is a PWM control unit that controls the light emission quantity per unit time at the light sources by varying duty ratios in accordance with the distance.

4. The lighting device according to claim 2, wherein the light quantity adjusting unit adjusts a light emission quantity per unit time by varying a value of current supplied to the plurality of light sources.

5. The lighting device according to claim 4, further comprising: a plurality of systems in each of which light sources among the plurality of light sources are connected in series, wherein each of the systems is driven at a corresponding constant current, and the light quantity adjusting unit is a resistor element that is connected in parallel to at least one of the light sources included in one of the systems so that a value of electric current flowing to the at least one light source differs.

6. The lighting device according to claim 1, wherein the plurality of light sources having luminous intensity ranks different from each other are arrayed.

7. A display apparatus, comprising: the lighting device according to claim 1 and a display panel that displays an image by using light radiated from the lighting device.
